(19) United States
(12) Patent Application Publication
(10) Pub. No.: US 2010/0169859 A1
(43) Pub. Date: Jul. 1, 2010

(54) DYNAMIC DATA PROCESSING APPLICATIONS WITH DATA PHASING AND WORK MANAGEMENT

(75) Inventors: Eric Bergman, Seattle, WA (US); Mikhail Leibman, Shoreline, WA (US); Dylan Meissner, Seattle, WA (US); Jarred Pine, Seattle, WA (US); Robin Sherwood, Seattle, WA (US)

Correspondence Address: SCHWABE, WILLIAMSON & WYATT, P.C., 1420 FIFTH, SUITE 3400, SEATTLE, WA, 98101-4010, US

(73) Assignee: DAPTIV, Seattle, WA (US)

(21) Appl. No.: 12/346,601

(22) Filed: Dec. 30, 2008

(51) Int. Cl. G06F 9/44

(52) U.S. Cl. 717/102

(57) ABSTRACT

Methods and apparatuses for defining and executing dynamic applications are disclosed herein. In various embodiments, an electronic library of work management entities is provided. In various embodiments, components are provided to enable definition of a plurality of record types, definition of a plurality of data phases for a business lifecycle, behaviors of the record types and selected ones of the work management entities in the various data phases, and workflow rules for the record types and the work management entities to flow through the data phases. The selected ones of the work management entities, the record types, the data phases, behaviors of the record types and the selected ones of the work management entities in the various data phases, and workflow rules for the record types and the selected ones of the work management entities to flow through the data phases, form a dynamic application. Other embodiments may also be described and claimed.

### TECHNICAL FIELD

Embodiments of the present disclosure relate to the field of data processing, in particular, to dynamic data processing applications.

### BACKGROUND

Traditionally, data processing applications are typically developed by highly trained, technically sophisticated software development professionals. While data processing applications developed in the traditional manner may be function rich and sophisticated, traditional application development has at least the disadvantage of requiring lengthy development time, leading to large backlog of unmet user needs.

Over the years, various advancements have enabled power users, who are not data processing professionals, to develop relatively straight forward data processing applications. For example, availability of software utilities like spreadsheet has enabled financial power users to develop various relatively basic financial data processing applications without the need of conventional software development professionals.

In recent years, various first generation dynamic data processing application platforms, including e.g. eProject Enterprise developed and available from Daptiv Inc. of Seattle, Wash., have become available to enable rapid data processing application development by non-software development professionals, e.g. information technology (IT) administrators. However, the capabilities of these first generation dynamic data processing application platforms are relatively basic, and can use improvement.

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1 illustrates an overview of the dynamic data processing application environment of the present disclosure, in accordance with various embodiments;

FIG. 2 illustrates the record types of the dynamic data processing application platform of the present disclosure in further details, in accordance with various embodiments;

FIG. 3 illustrates record lifecycle and workflow management of the dynamic data processing application platform of the present disclosure in further details, in accordance with various embodiments of the disclosure; and

FIG. 4 illustrates an example computer system suitable for use to practice an enterprise client device and/or a server to host the dynamic data processing application platform of the present disclosure, in accordance with various embodiments.

### DETAILED DESCRIPTION OF ILLUSTRATIVE EMBODIMENTS

Illustrative embodiments of the present disclosure include but are not limited to methods and apparatuses for providing a dynamic data processing application platform are described herein. Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

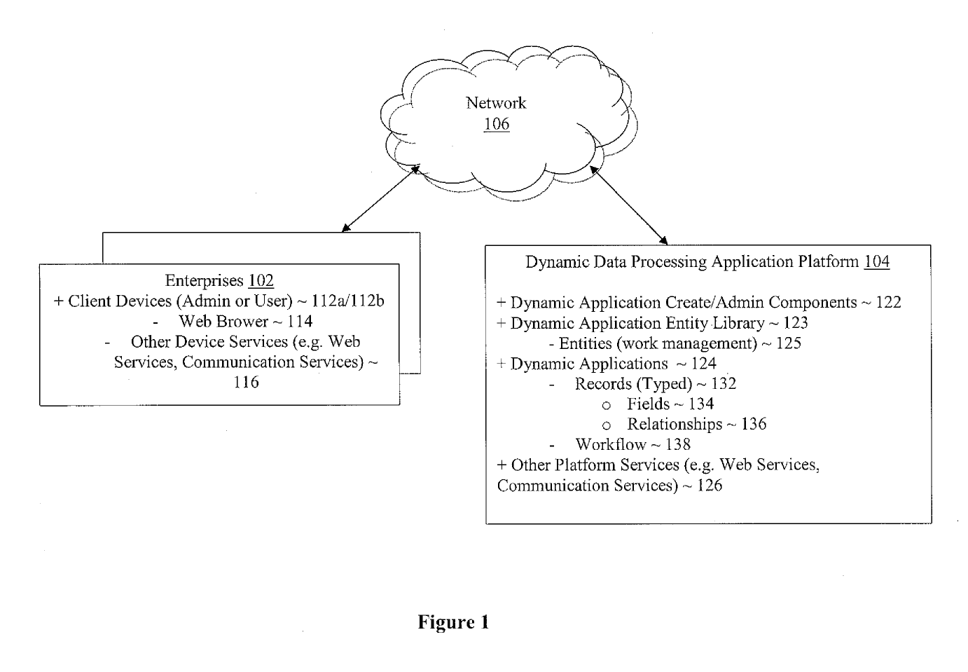

FIG. 1 illustrates an overview of the dynamic data processing application (DDPA) environment of the present disclosure, in accordance with various embodiments. As illustrated, for the embodiments, DDPA environment 100 of the present disclosure encompasses DDPA platform 104 hosted on one or more servers (not shown) of an offering enterprise (not shown). DDPA platform 104 includes various dynamic application creation and administration components 122 and associated entities 123, in particular, work management related entities 125, and the created dynamic applications 124. The work management related entities 125 include various scheduling and resource management entities. Typically, DDPA platform 104 also includes various system services, such as web services, communication services, operating system services and so forth, 126.

The functionality of the platform is exposed to the administrator and user client devices 112a and 112b of the subscriber enterprises 102 through networking fabric 106, which may include one or more private and public networks, including the Internet. In various embodiments, the functionality of the platform is exposed through web based interfaces (both user and application programming). Administrators and end-users client devices 112a and 112b of the subscribing enterprises access DDPA platform 104 using standard web browsers 114 on their client devices 112a and 112b. Typically, each client device 112a or 112b also includes various system services, such as web services, communication services, operating system services and so forth, 116.

Hereinafter, DDPA platform 104 may simply be referred to as dynamic application platform or DA platform, and the dynamic applications created thereon, accessible to the administrators and end users of the subscribing enterprises as DA.

For the purpose of this disclosure, including the claims, an enterprise is an entity that represents an organization that has purchased a subscription to the service offered by the platform. The term “subscriber” as used herein, in the specification and the claims, refers to an enterprise that enters into a subscription agreement with the enterprise that provides the dynamic data processing application platform to the particular as well as other subscribing enterprises.

Examples of subscribing enterprises include commercial as well non-commercial entities, such as a multinational enterprise like IBM, a state or municipal government, or a charity organization like the American Red Cross, or a conglomerate of these entities, such as the Internal Revenue Service and the State Department of the Federal Government, the separately operated military and the commercial aircraft divisions of an airplane manufacturer, the separately operated aircraft engine and nuclear reactor divisions of a large multi-national, and so forth

Associated with each enterprise are one or more enterprise members (administrators or end-users) who are granted an enterprise role that confers security privileges to the member. Some members (administrators) will have the ability to define DA functionality within their enterprise, while other will only be able to use the DA functionality defined by administrators.

Projects are entities within platform 104 that have intrinsic properties (budget, strategic value, etc.) and that contain other entities, such as tasks, documents and DA entities. Projects can be public, allowing all users to access them, or they can be secured, requiring users to be an explicit project member with one or more project roles that confer security privileges within the context of the project.

A DA 124 is a collection of entities (including user defined record types and selected ones of pre-provided work management entities), relationships and behaviors that address a specific business need. The user defined record types may extend, specialize, or include the semantics of the work management entities. Within an enterprise, multiple dynamic applications 124 can be defined to address multiple business needs and they can be configured to interact with each other and the DA platform 104 to model the complex business processes specific to any one customer enterprise.

The definition of a DA 124 includes using components 122 to define one or more dynamic record types or simply record type and their associated custom fields 134 and relationships 136 that represent a specific type of business data entity. The relationships may include relationships between user defined record types and selected ones of the provided work management entities 125. For example, a user could define a dynamic application 124 to manage expense reports which would include two record types, one to represent individual expense reports and one to represent the individual line items that appear on an expense report. The expense report record type would define custom fields to capture information about the person submitting the report, the date of submission and the total amount being submitted. The line item record type would define custom fields to capture information about each specific item being expensed, such as the description, the date and cost and an expense category. The expense report record type may be linked with selected ones of the work management entities to enable the expenses to be associated with particular projects or tasks, and/or included with reports generated to analyze planned versus actual costs.

Once a dynamic application 124 and its associated record types are defined, users can then access the dynamic application 124 to create instances of the dynamic record types, called dynamic records or simply records 132. In the example above, each time a user submits an expense report, they would be creating one expense report record and one or more line item records, and the records are automatically links to the associated projects and/or tasks. Management may use reporting and/or dashboard functions of DDPA platform 104 to get a real time view of current expenses and statuses of the projects or tasks.

Throughout this document, two examples will frequently be referenced, each from very different business domains: expense management and agile software development. Both are rife with existing software products and solutions that are written specifically for those domains. The examples in this document are not meant to illustrate a differentiation between the DA platform 104 of the present disclosure and these domain specific products based on domain specific features and capabilities. Instead, the examples in this document illustrate the ability of the DA platform 104 of the present disclosure to be configured by administrators of a subscribing enterprise in such a way as to match features of domain specific products. It is the abstraction of features into a configurable platform that represent the core innovation of the DA platform 104 of the present disclosure.

Multiple Record Types

Administrators of a subscribing enterprise may use components 122 to define one or more record types, each with its own custom fields. In this way, one dynamic application 124 can encompass multiple distinct business entities and the relationships between them.

### EXAMPLES

1. Expense Management. As described above, a DA 124 could be created using the DA platform 104 of the present disclosure to manage expense reports. This example DA 124 may have two record types-one type to represent an expense reports and associated properties (who is submitting, date of submission, total amount being submitted, dispersal status, etc.) and one type to represent individual expense line items and their associated properties (name, descriptions, expense category, expense amount, etc.)

2. Agile Software Development. Agile software development methodologies prescribe that a project (which represents, for example, the release of a new product) be divided into several short consecutive cycles of work, often referred to as sprints, each with a distinct set of objectives and tasks to be completed. To help manage an agile project, a DA 124 can be created with three record types:

i) Release. This record type represents the overall software project and its related properties (name, release date, strategic and business value, priority, budget, etc.). An engineering team is likely to have multiple simultaneous releases being worked.

ii) Sprint. This record type represents a cycle of work (objectives, start date, end date, total amount of work required, etc.

iii) Task. This record type represents an activity to be completed (description, start date, end date, amount of work, the person assigned to perform the work, percent complete, etc.). For this example, the record type may be a variant of a task object provided as part of the work management entities 125 of the platform 104. The timesheet work management entities may be used to compare the amount of time actually consumed performing these tasks to the amount of planned time.

Relationships Between Record Types

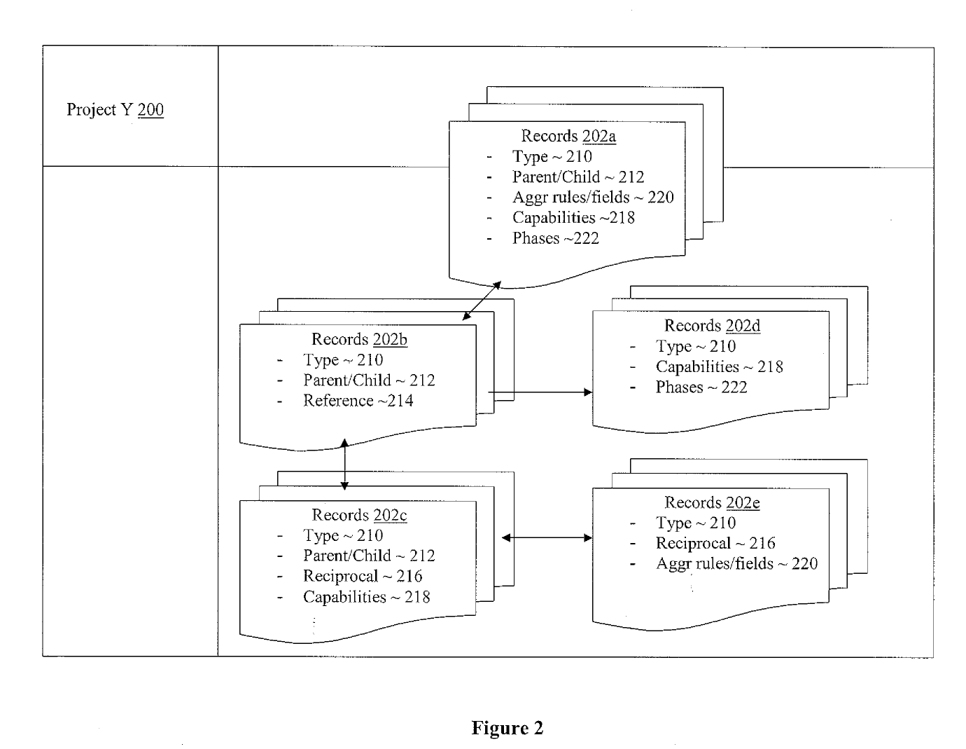

Referring now to FIG. 2, wherein the records of the DA platform 104 of the present disclosures are illustrated in further details, in accordance with various embodiments. The power of multiple record types lies in the ability to use components 122 to define intrinsic relationships between the record types (and selected ones of the pre-provided work management entities, including but not limited to projects, tasks, timesheet entries, and status updates. These relationships govern the organizational/hierarchical nature of record and the manner in which data is aggregated across records.

Hierarchical (Parent-Child) Relationships

When defining a record type (e.g. 202b, 202c), it is possible to use components 122 to specify another record type (or a work management entity), e.g. 202a, 202b, as the “parent”. In various embodiments, each record type (or a work management entity), (202a, b, c) may include a type identifier field 210 and a parent/child field 212 to denote the parent and child relationship. For example, in the expense report application, the line item record type would specify the expense report record type as its parent. This mirrors expectations about expense reports, in that each line item has a unique parent expense report and each expense report contains multiple “child” line items. Similarly, in the agile application, the task record type would specify the sprint record type as its parent.

The nature of a parent-child relationship can be further configured to indicate whether or not a child record is required to have a parent record. For example, in the expense report application, a likely configuration is to require that all line items have an associated parent expense report. Individual line items cannot be submitted independently. On the other hand, in the agile application, it is reasonable to have tasks that are not associated with a sprint. Such tasks are generally future tasks that are not yet planned for a specific execution cycle, but the work has nonetheless been identified.

When a parent-child relationship exists between record types, aggregation rules 220 can then be defined to allow data from child records to be aggregated and summarized in various views and reports as properties of the parent. For example, in the expense management application, the expense report record type defines a field called Total Expense, while the line item record type defines a field called simply Expense. The Total Expense field is defined to be an aggregation of the Expense field across all child line items. Thus, as a user is entering line items for their expense report, the Total Expense field on the expense report is being dynamically updated.

The aggregation rules can be conditional as well and use properties of the child to determine whether or not the data from a particular child should be used in the aggregation. For example, the expense report application can define additional fields to aggregate expenses for specific categories, such as Travel, Lodging, Food and Other. Which line items contribute to which aggregate is determined by the expense category of the line item

And just as properties of children records can be aggregated and regarded as intrinsic properties of their associated parent record, so too can the properties of a parent can be regarded as intrinsic properties of its child records. This is due to the uniqueness (there can only be one) of a parent. For example, in the expense management application, the expense report record type could include a field to indicate which departmental budget the expenses are being reported against. Thus, by virtue of inheritance via the parent-child relationship between line items and expense reports, every line item also has an associated departmental budget, even though this is not one of the explicitly defined properties of the line item record type

Cross Reference Relationships

In various embodiments, components 122 may also be used to define one or more cross reference relationships 214 between the defined record types (or a work management entity), e.g. 202b referencing 202d. A cross reference relationship is similar to a parent-child relationship, but instead of reflecting a hierarchical relationship between record types, it provides a means of categorizing records of one type based on properties of one or more other records types. Moreover, the properties of the referenced record type can be regarded as intrinsic properties of the referencing record type (this is identical to a child record “inheriting” properties of its parent). They can be used in various views and when defining rules that govern business processes.

For example, in the expense management application, a new record type can be created to represent expense categories. The expense category record type could contain e.g., two fields: Name and Expense Limit. The line item record type would then define a cross reference relationship with the expense category record type and the nature of the relationship would indicate that the expense category name should appear as an intrinsic property of a line item (whereas previously, expense category was a field defined explicitly as part of the line item record type).

In this particular example, a typical user is unlikely to know (or care) that the expense category is the result of a cross reference relationship and not just an explicit property of the line item, but it enables more powerful business processes to be modeled. A rule could be defined that requires that any expense report containing any line items that exceed the expense limit for the referenced expense category must not only be approved by an individual's manager, but by the head of the department as well. Thus, by virtue of the cross reference relationship, each line item inherits properties of an expense category allowing for categorization and process enforcement.

Reciprocal Relationships

The strict nature of parent-child and cross-reference relationships make them well suited for modeling well defined business rules and processes. To allow for less rigid organization of information, components 122 may be used to define reciprocal relationships 216 as well (e.g. 202c and 202e). These are characterized by the lack of a unique parent (or referred) record and the ability for any one record to be related to any number of other records. For example, the agile application could include a fourth record type “defect” to represent defects uncovered during testing of the software under development. A reciprocal relationship could then be defined between defects and tasks. Thus, any one task could have one or more defects related to it and any given defect could have one or more tasks related to it. There is no inherent business rule that dictates that a defect has a unique “parent” task or that a task has a unique parent defect.

A reciprocal relationship still allows for one record to aggregate data from records related to it. For example, the task record type could include a field that computes an average severity level of all defects associated with it.

Unlike parent-child and cross-reference relationships, reciprocal relationships do not allow for the inheritance of properties from one record to another. The “many-to-many” nature is only suited for aggregation.

Capabilities

In various embodiments, components 212 may be used to abstract “native” behavior as a dynamic capability 218 that can be included in the definition of a record type. When a capability is included, one or more fields are automatically defined by components 212 for the record type as well as any relevant relationships between the fields and rules that govern how other components of the system will interact with the records.

Calendaring

In various embodiments, components 212 support a calendaring capability. A calendaring capability will cause automatic definition for a record type fields and behaviors similar to appointments and meetings in a standard corporate email application. Fields include start and end dates, recurrence information and reminder flags. The system may enforce rules such as the start date must precede the end date. In various embodiments, records with the calendaring capability may appear in the calendar component of the DA platform and can be exported to and from external corporate email applications. Changes to the native work management entities may automatically update the schedule and change the start and end dates based on the projected effort or duration, and including the schedules of the assigned resources.

Work Management

In various embodiments, components 212 support a work management capability. The work management capability includes fields and behaviors that enable users to be assigned work against records and for this work to appear in planning tools and in users timesheets where users can enter work against records. Components 212 may automatically include fields like planned start, planned finish, actual start, planned work, actual finish, actual work, percent complete and estimated time to complete (ETC). Some of the enforced rules may include start dates preceding end date and non-negative work values. Various algorithms may be automatically included for computing percent complete from ETC (and vice versa)—components 122 may automatically perform the necessary calculation so that users may choose to enter either percent complete or ETC, but not both.

For example, the task record types defined as part of the example agile application would include the work management capability. This, combined with the ability to aggregate information to the parent sprint, allows project managers to track overall progress or work. A user may update both their timesheet and the task status in a single operation, and the project status may be derived from that information.

Scheduling

In various embodiments, components 212 support a scheduling capability. The scheduling capability includes fields and behaviors that enable records to affect a project schedule based on start and end dates and on dependencies on other work activities. Records with the scheduling capability may be subject to one or more scheduling rules automatically enforced. The scheduling capability may also be employed to enable work management of platform 104 to schedule, level and/or assign particular resources.

Aggregate Fields

In various embodiments, when a parent-child relationship exists between record types, components 212 allow definition of aggregate fields 220 on the parent record type. These fields would perform summary calculations (sum, min, max, average, count) using data from all or a subset of child records. The subset would be defined based on criteria defined using properties of the child record types. Aggregate fields 220 can also be defined when a reciprocal relationship exists. Examples are described above, under the parent-child and reciprocal relationship sections.

Cross Reference Fields

In various embodiments, when a cross reference relationship exists, components 122 are further configured to allow one or more fields from the referenced record type to be designated to appear as an intrinsic field on the referencing record type. An example is described above, under the cross reference relationships section

Data Phasing

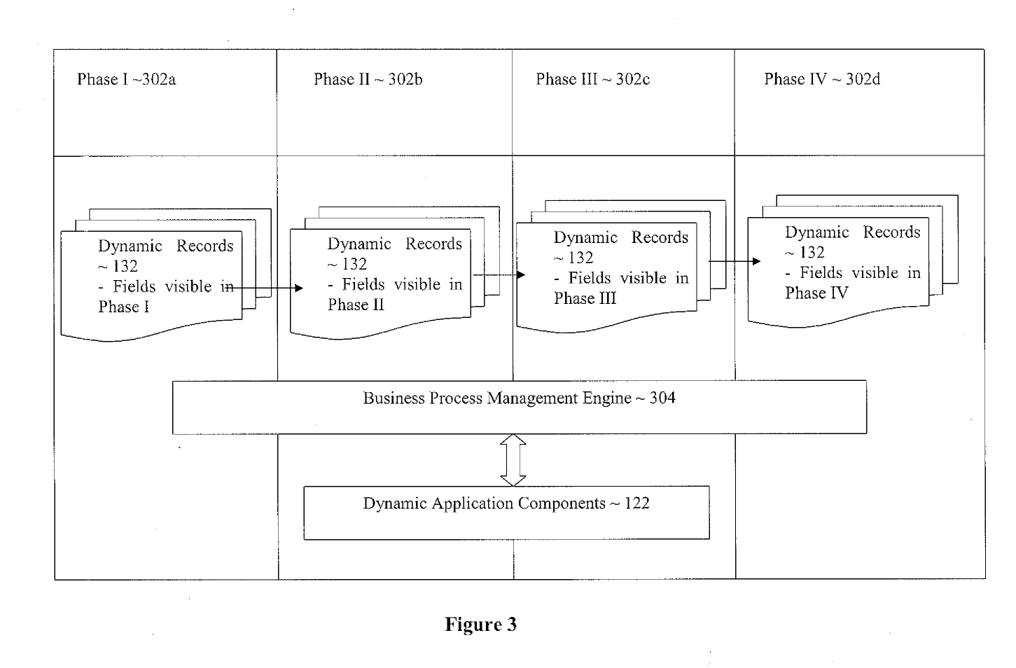

In various embodiments, components 212 further support definition of phases 222 for the defined records. Records (and other types of entities) progress through a lifecycle comprising a number of phases 302a-302d (FIG. 3) to allow modeling of dynamic business processes. As actions occur (e.g. expense report submitted or approved) or data is updated (e.g. budget of a project is increased) or as time passes (e.g. task become overdue), components 122 automatically move records from one phase of their lifecycle to another. The ability for a user to view or take action on any given record (or a work management entity) can be governed by the rules set the administrator for the current phase. Moreover, an administrator may configure certain fields be visible only to certain selected individual during different phases. Before further describe data phasing, it should be noted that while four phases are illustrated in FIG. 3, the present disclosure may be practiced with any number of 2 or more phases. One illustrative example is the native ability to handle resource requests for particular tasks. One user, the “project manager” can submit a request via the system to the “resource manager” asking for permission to assign a particular resource to a task.

The phases of a record (or a work management entity) and the rules governing field visibility and user access during the phases may be defined by the administrator defining the record type (and associating them with selected ones of the work management entities), using components 122. Phase definitions can utilize any of the custom fields associated with the record type, including aggregate and cross-reference fields associated with relationships between record types. For example, in the expense management application, a phase called “Needs VP Approval” could be defined for those expense reports that have individual line items that exceed the expense limit for the corresponding expense category. A custom field to indicate VP approval would be defined and only visible to those expense reports that entered this phase.

Dynamic Processes

Complementary to data phasing is the concept of workflow or business process management (BPM) engine 304 which is supported by components 122 in various embodiments to allow for the automated progression of a record through various phases of its lifecycle. There are numerous existing systems for the definition and execution of generic BPM processes, but these all require that the BPM engine be “educated” about the schema (format for storing data) and interfaces (methods for accessing and manipulating the data) of the various systems that will be involved in the processes. Only once the schema and interfaces are known does it become possible to define the rules for particular processes

In various embodiments of the DA platform 104 of the present disclosure, the BPM engine 304 are provided with explicit knowledge of the schema and interfaces of the DA 124 by DA platform 122, for the provided work management entities, as well as new record types, relationships and phases, as they are defined. The BPM engine 304 of the present disclosure can be used to define processes that directly utilize the entities of the present DA platform 104, in particular dynamic record types. For example, in the agile software development application, there were three record types: release, sprint and task. A traditional BPM system could be used to define processes using these entities, but it would do so in a generic manner. It would not understand the concept of a sprint or a task. Instead, it would only understand the concept of a dynamic record. It would be up to the user defining a process to check an attribute to determine if a particular record is a sprint or a task. The BPM engine 304 of the present disclosure, on the other hand, by virtual of the information provided, would inherently understand what a task is and what a sprint is. Users simply have to focus on defining the processes.

Approval Process

Many dynamic processes and phase rules are centered around approvals and the approval process. Components 122 include an approvals framework that the created DA can utilize, both for ad-hoc approval (getting a manager to approve a time-off request) and formal approval processes (routing purchase orders through appropriate legislative and budgetary committees for review and approval).

Full Audit Information

In various embodiments, components 122 maintain full historical audit information for entities within the DA platform of the present disclosure, in particular dynamic records. This audit information may be utilized in various parts of the present DA platform, such as reporting, trend analysis and forecasting. It will also be available to the BPM system so that processes can be defined that utilize historical information, either to drive execution of a process or to initiate a process (e.g. if the budget of a project is increased multiple times within a specified period of time, then a process could be initiated to facilitate review of the project by a steering committee).

Usage Analysis

In addition to capturing historical audit information, components 122 are further endowed with the functionality to capture extensive information about user activity. The DA platform 104 of the present disclosure is configured to perform predictive analysis based on usage statistics together with historical information to provide insight to managers and stakeholders regarding the likely success of a particular project or initiative. In particular, DA platform 104 may use the information for an application to provide trends or advises for the associated business process. DA platform 104 may also use the information for multiple applications of an enterprise to provide cross applications/business processes trends or advises for the associated enterprise.

In various embodiments, components 122 are further configured to support automatic computation of the interestingness or importance of a project. Interestingness or importance of a project may be inferred from how actively the project and the contained items are accessed and updated, both by members of the project and those not directly involved.

In various embodiments, components 122 are further configured to be able to analyze data from thousands of projects across multiple industries, enabling cross-company comparisons and recommendations for improvement and best practices.

Shared Queue/Ranking

In various embodiments, components 122 are further configured with the ability to rank dynamic application records in a project to provide a “natural ordering” based on relative position in the list. A common application of this capability will be to track priority of items based on their relative rank. For example, in the agile software development application, the order in which the tasks are to be completed is based on priority.

In various embodiments, components 122 are further configured to support setting of new ranking capability through a simple drag and drop operation or a simple edit to a single record, with other affected records updated automatically.

In various embodiments, components 122 are further configured to support a customizable “shared” ranking capability. Not only will the records in a project have a rank relative to a project, but they can be assigned a “personal” rank by individual users and a “global” rank across the enterprise. It is then possible for a custom weighting algorithm to be defined so that the personal ranking of selected individuals is used to establish the project or global ranking. For example, in agile software development, the goal is to develop the features that are deemed the most important (highest priority). However, the determination of importance requires input from several stakeholders (executives, marketing, customer support, etc.). A ranking algorithm allows stakeholders to “vote” for the most important feature and the weighting allows for the votes of selected individuals to count for more or less than those of others.

In various embodiments, the shared ranking capability is configured to work with the security model of the DA platform of the present disclosure, so that individuals may still create a personal ranking of records, even if they do not have access to all records in the collection. Moreover, the custom ranking algorithm can then be defined in such a way as to account for these limited personal rankings.

Project Binder

In various embodiments, components 122 are further configured to support a Project Binder feature that allows a user assigned a project manager role to combine various artifacts from a project (documents, reports, schedules, budget information, dynamic application records and reports, etc.) into a cohesive package (binder) that can be shared with stakeholders to provide more detailed status during execution of a project or wrap-up after a project is completed. The binder includes presentation capabilities (like Powerpoint) where slide content is easily be pulled from existing project artifacts with automatically generated links back to the original content. Multiple binders can be created for any project to show progress over time. The Binder can include “public” views, so that it can be shared with users not directly associated with the project (in fact, with users that do not even have an account).

Those skilled in the art would appreciate that, with dynamics applications being a central component, the DA platform of the present disclosure enables the relatively easy creation of additional solutions for various application segments (such as IT Operations Management) outside the realm of traditional project and portfolio management (PPM). These additional solutions may be created by both an offeror of the DA platform of the present disclosure or its partners, through configuration only, without the need for custom code provided by software development professionals. Further, a typical solution may comprise more than just dynamic applications. The solution may also include (but is not limited to) project type definitions, enterprise and project roles, dynamic process and approval definitions and connectors to external systems (such as a financial accounting system) to enable data and process integrations.

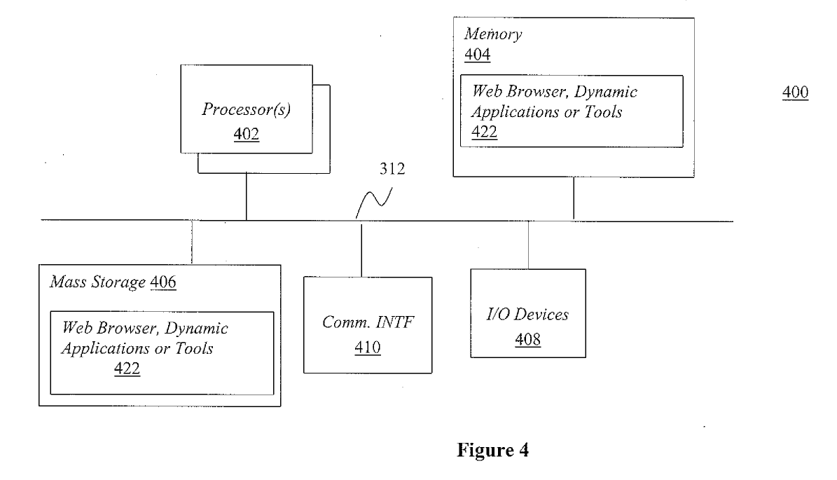

FIG. 4 illustrates an example computer system suitable for use to practice the client and/or server aspect of the present disclosure, in accordance with various embodiments. As shown, computer system 400 includes one or more processors 402 and system memory 404. Additionally, computer system 400 includes input/output devices 408 (such as keyboard, cursor control, and so forth). The elements are coupled to each other via system bus 412, which represents one or more buses. In the case of multiple buses, they are bridged by one or more bus bridges (not shown). Each of these elements performs its conventional functions known in the art. In particular, system memory 404 and mass storage 406 are employed to store respectively a working copy and a permanent copy 422 of the programming instructions implementing the DA platform 104 and DA 124 (if system 400 is used a host server) or the web browser for accessing the DA platform 104 and DA applications 124 (if system 400 is used an administrator or user client device). The permanent copy 422 of the programming instructions may be loaded into mass storage 406 in the factory, or in the field, through a distribution medium (not shown) or through communication interface 410. The constitution of these elements 402-412 is known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present disclosure. This application is intended to cover any adaptations or variations of the embodiments discussed herein. Therefore, it is manifestly intended that this disclosure be limited only by the claims and the equivalents thereof.

What is claimed is:

1. A computer implemented method comprising:
providing an electronic library having a plurality of work management related entities configured to enable a plurality of user defined record types to be associated with selected ones of the work management related entities to form a dynamic application associated with the operation and management of a business process;
facilitating an administrator operating a administrator client device, from a server remotely disposed from the administrator client device, in defining the plurality of record types associated with the business process;
facilitating the administrator in defining a plurality of data phases for a business lifecycle of the business process, behaviors of the record types and selected one of the work management entities in the various data phases, and workflow rules for the record types and the work management entities to flow through the data phases, wherein the record types, the data phases, the behaviors of the record types and the work management entities in the various data phases, and the workflow rules for the record types and the work management entities to flow through the data phases, form a dynamic application; and
facilitating one or more users operating one or more corresponding user client devices, from a server remotely disposed from the user client devices, in executing the dynamic application in association with operating and managing the business process through the defined business lifecycle.

2. The method of claim 1, wherein said facilitating defining of behaviors of the record types and selected one of the work management entities in the various data phases comprises facilitating defining a user's view of a record instance of a record type, or a user's view of an instance of a selected one of the work management entities, during a data phase of the business lifecycle.

3. The method of claim 1, wherein said facilitating defining of behaviors of the record types and selected one of the work management entities in the various data phases comprises facilitating defining permissible user actions on a record instance of a record type, or an instance of a selected one of the work management entities, during a data phase of the business lifecycle.

4. The method of claim 1, wherein said facilitating defining of behaviors of the record types and selected one of the work management entities in the various data phases comprises facilitating defining a progression condition for record instances of a record type, or instances of the selected ones of the work management entities, to progress from one data phase to another data phase of the business lifecycle.

5. The method of claim 1, wherein said facilitating execution of the dynamic application comprises logging changes to record instances of the record types, or instances of the selected ones of the work management entities, to provide an audit trail for the execution.

6. The method of claim 1, wherein said facilitating execution of the dynamic application comprises logging user activities to enable analysis based on the logged user activities.

7. The method of claim 6, wherein said analysis comprises computing a collaborative earned value of a project comprising various record instances of the record types and selected ones of the work management entities, and correlating activities surrounding the project to a likelihood of success of the project.

8. The method of claim 6, wherein said analysis comprises calculating an interestingness or importance of a project comprising various record instances of the record types and selected ones of the work management entities.

9. The method of claim 6, wherein said analysis comprises analyzing execution of the dynamic applications by different entities, and providing recommendation for best practices.

10. The method of claim 1, further comprising facilitating defining a plurality of relationships between selected ones of the record types and selected ones of the work management entities.

11. An apparatus comprising:
a networking interface;
a processor coupled to the networking interface;
a storage medium coupled to the processor, and having stored therein an electronic library having a plurality of work management related entities and a plurality of dynamic application creation and execution components,
wherein the work management related entities are configured to enable a plurality of user defined record types to be associated with selected ones of the work management related entities to form a dynamic application associated with the operation and management of a business process, and
wherein the dynamic application creation and execution components are configured to facilitate an administrator client device coupled to the apparatus via a network to create a dynamic application by defining a plurality of record types, and defining a plurality of data phases for a business lifecycle, behaviors of the record types and selected ones of the work management entities in the various data phases, and workflow rules for the record types and selected ones of the work management entities to flow through the data phases, wherein the selected ones of the work management entities, the record types, the data phases, the behaviors of the record types and selected one of the work management entities in the various data phases, and the workflow rules for the record types and selected one of the work management entities to flow through the data phases, form a dynamic application, and to execute the created dynamic application.

12. The apparatus of claim 11, wherein the components are configured to enable the administrator client device to define a user's view of a record instance of a record type, or an instance of a selected one of the work management entities, during a data phase of the business lifecycle.

13. The apparatus of claim 11, wherein the components are configured to enable the administrator client device to define permissible user actions on a record instance of a record type, or an instance of a selected one of the work management entities, during a data phase of the business lifecycle.

14. The apparatus of claim 11, wherein the components are configured to enable the administrator client device to define a progression condition for record instances of a record type, or an instance of a selected one of the work management entities, to progress from one data phase to another data phase of the business lifecycle.

15. The apparatus of claim 11, wherein the components are configured to log changes to record instances of the record types, or instances of the selected ones of the work management entities, to provide an audit trail for the execution.

16. The apparatus of claim 11, wherein the components are configured to log user activities to enable analysis based on the logged user activities.

17. The apparatus of claim 16, wherein the components are configured to compute a collaborative earned value of a project comprising various record instances of the record types and instances of the selected one of the work management entities, and correlate activities surrounding the project to a likelihood of success of the project.

18. The apparatus of claim 16, wherein the components are configured to calculate an interestingness or importance of a project comprising various record instances of the record types and instances of the selected one of the work management entities.

19. The apparatus of claim 16, wherein the components are configured to analyze execution of the dynamic applications by different enterprise entities, and provide recommendation for best practices.

20. An article of manufacture comprising
a computer readable storage medium; and
programming instructions stored in the stored medium and configured to program an apparatus to enable an apparatus to
facilitate an administrator operating an administrator client device remotely disposed from the apparatus in defining a plurality of user record types associated with operating and managing a business process;
facilitating the administrator in defining a plurality of data phases for a business lifecycle, behaviors of the record types and selected ones of a plurality of pre-provided work management entities in the various data phases, and workflow rules for the record types and the selected ones of the work management entities to flow through the data phases, wherein the work management entities, the record types, the data phases, the behaviors of the record types and the work management entities in the various data phases, and the workflow rules for the record types and the work management entities to flow through the data phases, form a dynamic application for operating and management the business process through the business lifecycle.

21. The article of claim 20, wherein said facilitating defining of behaviors of the record types the selected ones of the work management entities in the various data phases comprises facilitating defining a user's view of a record instance of a record type, or a user's view of an instance of a selected one of the work management entities, during a data phase of the business lifecycle.

22. The article of claim 20, wherein said facilitating defining of behaviors of the record types or selected ones of the work management entities in the various data phases comprises facilitating defining permissible user actions on a record instance of a record type, or an instance of a selected one of the work management entities, during a data phase of the business lifecycle.

23. The article of claim 20, wherein said facilitating defining of behaviors of the record types and the selected ones of the work management entities in the various data phases comprises facilitating defining a progression condition for record instances of a record type or an instance of a selected one of the work management entities to progress from one data phase to another data phase of the business lifecycle.
